(19) United States
(12) Patent Application Publication
(10) Pub. No.: US 2024/0416634 A1
(43) Pub. Date: Dec. 19, 2024

(54) IMPACT ABSORBING MATERIAL AND METHOD OF FORMING

(71) Applicant: H.B. Fuller Company, St. Paul, MN (US)

(72) Inventors: Richard B. Sergeant, Valloire sur Cisse (FR); Isabel Fonseca, Rio Tinto (PT)

(21) Appl. No.: 18/742,154

(22) Filed: Jun. 13, 2024

Related U.S. Application Data
(60) Provisional application No. 63/508,691, filed on Jun. 16, 2023.

(51) Int. Cl. B32B 29/00; B32B 1/00; B32B 3/08; B32B 7/12; B32B 37/12; B65D 81/127

(52) U.S. Cl. CPC B32B 29/005; B32B 1/00; B32B 3/085; B32B 7/12; B32B 37/1207; B65D 81/127; B32B 2037/1215; B32B 2307/72; B65D 2581/053

(57) ABSTRACT

A multilayered structure that includes a first layer having a first sheet of repulpable material, and second layer in direct contact with the first layer and including a hot melt adhesive composition in foam form such that a density of the second layer is no greater than 0.85 g/cc and the second layer exhibits a residual deformation value of no greater than 10%.

### CROSS REFERENCE TO RELATED APPLICATIONS

This application claims the benefit of U.S. Provisional Application No. 63/508,691, filed Jun. 16, 2023, and is incorporated herein.

### FIELD

The present disclosure relates to one or more hot melt adhesive compositions in a foam form. More specifically the present disclosure relates to one or more hot melt adhesive compositions configured to help provide a protective enclosure.

### BACKGROUND

To protect an object while it is in transit, such as while being shipped through the mail, protective devices such as various wraps, envelopes, packages, and containers are currently used. Such protective devices may be placed in surrounding engagement with the object being shipped to protect the object from potentially damaging contact, such as impacts directed at the object. Such protective devices may be used to form an enclosure that provides an impact absorbing layer which permits the product to be shipped in a protective manner.

Currently available protective options may include plastic bubble wrap, polystyrene foams, or other environmentally unsound materials. Alternative approaches include more eco-friendly, biodegradable materials. Such protective products often have certain drawbacks including being very heavy or bulky, nonuniformity in the protective layer, and/or lack of the necessary protective qualities. For example, some protective products that rely on biodegradable and/or compostable fillers that are not secured to the layer that is in surrounding engagement with the object end up with air gaps at various locations. The layer that is in surrounding engagement with the object can become compressed and the protection can become less effective in those compressed areas.

There is a need for a protective option for enclosing an object. There is a need for a repulpable protective option for enclosing an object.

### SUMMARY

Disclosed herein is a multilayered structure that includes a first layer having a first sheet of repulpable material, the first layer having a first side defining a first face, and a second layer in direct contact with the first face of the first layer and including a hot melt adhesive composition in foam form such that a density of the second layer is no greater than 0.85 g/cc.

In some aspects, the hot melt adhesive composition comprises from 10 wt. % to 50 wt. % a SEBS block copolymer, from 15 wt. % to 60 wt. % oil, and from 10 wt. % to 50 wt. % a tackifying resin. In some aspects, the hot melt adhesive composition comprises from 10 wt. % to 50 wt. % a SEBS block copolymer, from 15 wt. % to 60 wt. % mineral oil, and from 5 wt. % to 50 wt. % a tackifying resin. In some aspects, the hot melt adhesive composition comprises from 10 wt. % to 50 wt. % a SEBS block copolymer, from 15 wt. % to 60 wt. % mineral oil, and from 5 wt. % to 50 wt. % a styrenic polymer tackifying resin. In some aspects, the hot melt adhesive composition comprises from 10 wt. % to 50 wt. % a SEBS block copolymer, from 15 wt. % to 60 wt. % mineral oil, and from 10 wt. % to 50 wt. % a styrenic polymer tackifying resin. In some aspects, the hot melt adhesive composition comprises from 15 wt. % to 45 wt. % a SEBS block copolymer, from 20 wt. % to 55 wt. % mineral oil, and from 20 wt. % to 40 wt. % a styrenic polymer tackifying resin. In some aspects, the hot melt adhesive composition comprises from 20 wt. % to 40 wt. % a SEBS block copolymer, from 35 wt. % to 50 wt. % mineral oil, and from 20 wt. % to 25 wt. % a styrenic polymer tackifying resin. In some aspects, the tackifying resin is a modified styrenic tackifier. In some aspects, the styrenic polymer tackifying resin is a styrenic copolymer tackifying resin.

In some aspects, the hot melt adhesive composition exhibits a peak separation force of no greater than 0.1 N, when measured in accordance with the Tack Test Method. In some aspects, the second layer exhibits a residual deformation value of no greater than 10% when tested according to the Residual Deformation Test. In some aspects, the second layer exhibits a residual deformation value of no greater than six % when tested according to the Residual Deformation Test. In some aspects, the second layer exhibits a residual deformation value of no greater than four % when tested according to the Residual Deformation Test.

In some aspects, the repulpable material comprises at least one from the group of paper, papyrus, cardboard, and paperboard. In some aspects, the second layer comprises a plurality of impact absorbing pads positioned in direct contact with the first layer, each pad of the plurality of energy absorbing pads positioned at a fixed location on the first face and distanced from each of the other pads of the plurality of impact absorbing pads. In some aspects, the second layer defines a thickness of from about 0.1 millimeter to about 200 millimeters.

In some aspects, the density of the second layer is no greater than 0.50 g/cc. In some aspects, the density of the second layer is no greater than 0.25 g/cc.

In some instances, the multilayered structure further includes a third layer in direct contact with the second layer, the third layer comprising a second sheet of repulpable material. In some instances, the multilayered structure further includes a third layer in direct contact with the second layer, the third layer comprising a second sheet of repulpable material defining a second face; and a fourth layer in direct contact with the second face of the third layer and comprising a hot melt adhesive composition in foam form such that a density of the fourth layer is no greater than 0.85 g/cc.

Disclosed herein is an enclosing article having a first wall comprising the multilayered structure, the first wall defining an outer edge, and a second wall comprising the multilayered structure, the second wall defining an outer edge. The first wall and second wall are attached to one another along at least one side of the outer edge of the first wall and the outer edge of the second wall.

Disclosed herein is an enclosing article having a first wall comprising the multilayered structure, the first wall defining an outer border, and a second wall defining an outer border. The first wall and second wall are attached to one another in facing relationship and along the outer border of the first wall and the outer border of the second wall. Disclosed herein is an enclosing article having a first wall that includes a third layer in direct contact with the second layer and defining an outer border, and a second wall that includes a third layer in direct contact with the second layer, the second wall defining an outer border. The first wall and second wall are positioned in facing relationship and attached to one another along the outer border of the first wall and the outer border of the second wall.

In some aspects, the enclosing article is at least one from the group of an envelope, a box, a cylinder, and a bag.

Disclosed herein is a multilayered structure including a first layer comprising a sheet of repulpable material, the first layer defining a first face, and a second layer in direct contact with the first face of the first layer and comprising a hot melt adhesive composition defining a bulk material, the bulk material defining voids throughout the second layer. The second layer exhibiting a residual deformation value of no greater than 10% when tested according to the Residual Deformation Test.

In some aspects, the second layer comprises the hot melt adhesive composition in foamed form and exhibits a residual deformation value of no greater than six % when tested according to the Residual Deformation Test. In some aspects, the second layer comprises the hot melt adhesive composition in foamed form and exhibits a residual deformation value of no greater than four % when tested according to the Residual Deformation Test.

In some aspects, the second layer includes a hot melt adhesive composition in a foam form. In some aspects, the density of the second layer is no greater than 0.85 g/cc. In some aspects, the density of the second layer is no greater than 0.50 g/cc. In some aspects, the density of the second layer is no greater than 0.25 g/cc.

In some aspects, the hot melt adhesive composition comprises from 10 wt. % to 50 wt. % a SEBS block copolymer, from 15 wt. % to 60 wt. % mineral oil, and from 10 wt. % to 50 wt. % a styrenic polymer tackifying resin. In some aspects, hot melt adhesive composition comprises from 15 wt. % to 45 wt. % a SEBS block copolymer, from 20 wt. % to 55 wt. % mineral oil, and from 20 wt. % to 40 wt. % a styrenic polymer tackifying resin. In some aspects, the hot melt adhesive composition comprises from 20 wt. % to 40 wt. % a SEBS block copolymer, from 35 wt. % to 50 wt. % mineral oil, and from 20 wt. % to 25 wt. % a styrenic polymer tackifying resin. In some aspects, the tackifying resin is a modified styrenic copolymer.

In some aspects, the hot melt adhesive composition is in a foamed form and exhibits a peak separation force of no greater than 0.1 N, when measured in accordance with the Tack Test Method. In some aspects, the repulpable material comprises at least one from the group of paper, papyrus, cardboard, and paperboard. In some aspects, the second layer comprises a plurality of impact absorbing pads positioned in direct contact with the first layer, each pad of the plurality of energy absorbing pads positioned at a fixed location on the first face and distanced from each of the other pads of the plurality of energy absorbing pads. In some aspects, the second layer defines a thickness of from about 0.1 millimeter to about 200 millimeters.

In some aspects, the multilayered structure further includes a third layer in direct contact with the second layer, the third layer comprising a second sheet of repulpable material.

Disclosed herein is an enclosing article having a first wall comprising the multilayered structure, the first wall defining an outer edge, and a second wall comprising the multilayered structure, the second wall defining an outer edge. The first wall and second wall are attached to one another along at least one side of the outer edge of the first wall and the outer edge of the second wall.

Disclosed herein is an enclosing article having a first wall comprising the multilayered structure, the first wall defining an outer border, and a second wall comprising the multilayered structure, the second wall defining an outer border. The first wall and second wall are attached to one another in facing relationship and along the outer border of the first wall and the outer border of the second wall.

Disclosed herein is an enclosing article having a first wall comprising the multilayered structure, the first wall defining an outer border, and a second wall comprising the multilayered structure, the second wall defining an outer border. The first wall and second wall are attached to one another in facing relationship and along the outer border of the first wall and the outer border of the second wall.

Disclosed herein is a multilayered structure including a first layer comprising a sheet of repulpable material and defining a first face, a second layer in direct contact with the first face of the first layer and comprising a hot melt adhesive composition in a foam form and configured to define an impact absorbing layer. In some aspects, the second layer exhibits a peak separation force of no greater than 0.1 N, when measured in accordance with the Tack Test Method. In some aspects, the second layer exhibits a residual deformation value of no greater than four % when tested according to the Residual Deformation Test.

In some aspects, the hot melt adhesive composition comprises from 10 wt. % to 50 wt. % a SEBS block copolymer, from 15 wt. % to 60 wt. % mineral oil, and from 10 wt. % to 50 wt. % a styrenic polymer tackifying resin. In some aspects, the hot melt adhesive composition comprises from 15 wt. % to 45 wt. % a SEBS block copolymer, from 20 wt. % to 55 wt. % mineral oil, and from 20 wt. % to 40 wt. % a styrenic polymer tackifying resin. In some aspects, the hot melt adhesive composition comprises from 20 wt. % to 40 wt. % a SEBS block copolymer, from 35 wt. % to 50 wt. % mineral oil, and from 20 wt. % to 25 wt. % a styrenic polymer tackifying resin. In some aspects, the tackifying resin is a modified styrenic copolymer.

Disclosed herein is a multilayered structure having a first layer comprising a sheet of repulpable material, the first layer having a first side, and a second side opposite the first side and defining a second face; a plurality of energy absorbing pads positioned in direct contact with the first layer, each pad of the plurality of energy absorbing pads positioned at a discrete location and separate from each of the other pads of the plurality of energy absorbing pads; and the second layer in direct contact with the second face of the first layer and comprising a hot melt adhesive composition defining a bulk material, the adhesive composition in foam form and exhibiting a density of no greater than 0.85 g/cc.

In some aspects, the second layer comprises the hot melt adhesive composition in foamed form and exhibiting a residual deformation value of no greater than 10% when tested according to the Residual Deformation Test.

In some aspects, the second layer comprises the hot melt adhesive composition in foamed form and exhibiting a residual deformation value of no greater than six % when tested according to the Residual Deformation Test. In some aspects, the second layer comprises the hot melt adhesive composition in foamed form and exhibiting a residual deformation value of no greater than four % when tested according to the Residual Deformation Test. In some aspects, the hot melt adhesive composition is in a foamed form and exhibits a peak separation force of no greater than 0.1 N, when measured in accordance with the Tack Test Method.

In some aspects, the hot melt adhesive composition comprises from 10 wt. % to 50 wt. % a SEBS block copolymer, from 15 wt. % to 60 wt. % mineral oil, and from 10 wt. % to 50 wt. % a styrenic polymer tackifying resin. In some aspects, the hot melt adhesive composition comprises from 15 wt. % to 45 wt. % a SEBS block copolymer, from 20 wt. % to 55 wt. % mineral oil, and from 20 wt. % to 40 wt. % a styrenic polymer tackifying resin. In some aspects, the hot melt adhesive composition comprises from 20 wt. % to 40 wt. % a SEBS block copolymer, from 35 wt. % to 50 wt. % mineral oil, and from 20 wt. % to 25 wt. % a styrenic polymer tackifying resin. The multilayered structure of claim 52, wherein the tackifying resin is a modified styrenic copolymer.

Disclosed herein is an enclosing article including a first wall; and a second wall. The first wall and second wall are positioned in facing arrangement to one another and bonded to each other along an outer border of each of the first and second wall. At least one of the first wall and the second wall include a first layer comprising a sheet of repulpable material, the first layer having a first side, and a second side opposite the first side and defining a second face, and a second layer in direct contact with the second face of the first layer and comprising a hot melt adhesive composition in foam form and exhibiting a density of no greater than 0.85 g/cc.

In some aspects, the second layer comprises a plurality of energy absorbing pads positioned in direct contact with the first layer, each pad of the plurality of energy absorbing pads positioned at a discrete location and separate from each of the other pads of the plurality of energy absorbing pads.

In some aspects, the second layer comprises the hot melt adhesive composition in foamed form and exhibiting a residual deformation value of no greater than 10% when tested according to the Residual Deformation Test. In some aspects, the second layer comprises the hot melt adhesive composition in foamed form and exhibiting a residual deformation value of no greater than six % when tested according to the Residual Deformation Test. In some aspects, the second layer comprises the hot melt adhesive composition in foamed form and exhibiting a residual deformation value of no greater than four % when tested according to the Residual Deformation Test.

In some aspects, the hot melt adhesive composition is in a foamed form and exhibits a peak separation force of no greater than 0.1 N, when measured in accordance with the Tack Test Method. In some aspects, the hot melt adhesive composition comprises from 10 wt. % to 50 wt. % a SEBS block copolymer, from 15 wt. % to 60 wt. % mineral oil, and from 10 wt. % to 50 wt. % a styrenic polymer tackifying resin. In some aspects, the hot melt adhesive composition comprises from 15 wt. % to 45 wt. % a SEBS block copolymer, from 20 wt. % to 55 wt. % mineral oil, and from 20 wt. % to 40 wt. % a styrenic polymer tackifying resin. In some aspects, the hot melt adhesive composition comprises from 20 wt. % to 40 wt. % a SEBS block copolymer, from 35 wt. % to 50 wt. % mineral oil, and from 20 wt. % to 25 wt. % a styrenic polymer tackifying resin. In some aspects, the tackifying resin is a modified styrenic copolymer. In some aspects, the enclosing article is at least one from the group of an envelope, a box, a cylinder, and a bag.

These embodiments are intended to be within the scope of the invention disclosed herein. These and other embodiments of the present invention will become readily apparent to those skilled in the art from the following detailed description of the various embodiments having reference to the attached figures, the invention not being limited to any particularly preferred embodiment(s) disclosed. Other features and advantages will be apparent from the following brief description of the drawings (where like reference numbers and designations in the various drawings indicate like elements), the description of the preferred embodiments, and from the claims.

### BRIEF DESCRIPTION OF THE DRAWINGS

FIG. 1 is a schematic view of a multilayered structure, in accordance with certain embodiments.

FIG. 2 is a schematic view of a multilayered structure, in accordance with certain embodiments.

FIG. 3 is a schematic view of a multilayered structure, in accordance with certain embodiments.

FIG. 4 is a side view of a multilayered structure, in accordance with certain embodiments.

FIG. 5 is a side view of a multilayered structure, in accordance with certain embodiments.

FIG. 6 is a side of an enclosure that includes a multilayered structure, in accordance with certain embodiments.

FIG. 7 is a side view of an enclosure that includes a multilayered structure, in accordance with certain embodiments.

### GLOSSARY

As used herein, “foamed” or a “foam” form is defined as a material that includes a bulk composition that defines voids throughout the material.

As used herein, a “repulpable” material is defined as any material wherein at least 85 wt. % of the material is made up of components that break down, or that can be broken down, into discrete particles that disperse in water to form a slurry.

As used herein, “paper” is defined as a sheet of material comprising the fibers of wood, rags, grasses, or other fibrous substances.

As used herein, “cardboard” is defined as a sheet of material comprising at least one layer of paper that is stiff enough to maintain a planar shape under the force of its own weight.

As used herein, “corrugated fiberboard” is defined as a sheet of material comprising at least a first layer of flat paper and a layer of fluted paper.

As used herein, “weight” is defined as the force acting on an object due to the acceleration of gravity, which is relative to the mass of the object.

### DETAILED DESCRIPTION

Disclosed herein is a hot melt adhesive composition in a foamed form. Disclosed herein is a hot melt adhesive composition in a foamed form that exhibits a residual deformation value of no greater than 10%, when measured with the Residual Deformation Test described herein. Disclosed herein is a hot melt adhesive composition that is free of residual staining when positioned on a substrate formed from a repulpable material. Disclosed herein is a hot melt adhesive composition that is tack free when in a solid phase. Disclosed herein is a hot melt adhesive composition in a foamed form that exhibits a residual deformation value of no great than 10%, when measured with the Residual Deformation Test, is free of residual staining when positioned on a substrate formed from a repulpable material, and is tack free when in a solid phase.

Disclosed herein is a hot melt adhesive composition that includes a styrenic block copolymer, a tackifier, and a plasticizer. In some embodiments, the hot melt adhesive composition includes a wax. In some embodiments, the hot melt adhesive composition includes from 10 wt. % to 50 wt. % the styrenic block copolymer, from 10 wt. % to 50 wt. % the tackifier, from 30 wt. % to 70 wt. % the plasticizer, and optionally from 10 wt. % to 30 wt. % the wax, based on the total weight of the hot melt adhesive composition. The hot melt adhesive composition is suitable for being positioned on a substrate as a liquid and then allowed to solidify to form a solid bot melt adhesive, with the solid hot melt adhesive in a foam form.

Disclosed herein is a hot melt adhesive composition in a foamed form positioned in direct contact with a substrate. The substrate can include at least one sheet of repulpable material. Disclosed herein is a padding layer that includes a foamed hot melt adhesive. In some embodiments, the hot melt adhesive can be configured as an impact absorbing layer. Disclosed herein is a hot melt adhesive in a foamed form positioned in direct contact with a repulpable material that is suitable for forming an enclosure.

### Composition

Disclosed herein is a padded layer that includes a hot melt adhesive composition. Hot melt adhesive compositions can be used in a variety of applications that require bonding to one or more substrates. Hot melt adhesive compositions are typically solid at room temperature. Hot melt adhesive compositions can be applied to a substrate when in a liquid phase (e.g., melted form), and then allowed to cool and harden (e.g., to transition to a solid phase). Hot melt adhesive compositions can be used to form a bond between two or more substrates.

Typically, the hot melt adhesive composition includes a polymer, a tackifier, and a plasticizer. Optional components may include at least one wax.

The polymer can help provide the hot melt adhesive composition with strength and adhesive characteristics. Typically, a thermoplastic polymer is used. The thermoplastic polymer may be a block copolymer (e.g., a styrene block copolymer). In some instances, further polymers such as, for example, an olefin polymer could also be present. In some instances, a hydrogenated block copolymer is preferred.

A styrene block copolymer can include an aromatic vinyl polymer block and a conjugated diene polymer block, a hydrogenated conjugated diene polymer block, or a combination thereof. The blocks can be arranged in a variety of configurations including, e.g., linear, branched, radial, star, tapered, multi-block, and combinations thereof. The aromatic vinyl polymer block can be derived from a variety of aromatic vinyl compounds including, e.g., styrene, alpha-methylstyrene, beta-methylstyrene, o-, m-, p-methylstyrene, t-butylstyrene, 2,4,6-trimethylstyrene, monofluorostyrene, difluorostyrene, monochlorostyrene, dichlorostyrene, methoxystyrene, 1,3-vinylnaphthalene, vinylanthracene, indene, acenaphthylene, and combinations thereof. The diene polymer block can be derived from a variety of diene-containing compounds including, e.g., isoprene, butadiene, hexadiene, 2,3-dimethyl-1,3-butadiene, 1,3-pentadiene, and hydrogenated versions thereof, and combinations thereof.

Suitable examples of the block copolymer can be a styrene block copolymer (SBC). The styrene block copolymer can have an unsaturated mid-block. Alternatively, the mid-block can be saturated, i.e., hydrogenated.

Useful styrene block copolymers include triblock, multi-arm and radial copolymers including, for example, styrene-isoprene-styrene (SIS), styrenebutadiene-isobutylene-styrene (SBBS), styrene-5 isoprene-butadiene-styrene (SIBS), styreneethylene/butene-styrene (SEBS) (such as a high diblock SEBS copolymer), styrene-ethylene/propylene-styrene (SEPS), styrene-ethyleneethylene/propylene-styrene (SEEPS), styrene-ethylene/butene/styrene-styrene (SEBSS), and combinations thereof. The styrene block copolymer can be at least one of SIS, SBBS, SEBS, SEPS, SIBS, SEEPS and SEBSS. The styrene block copolymer can be a blend of one or more styrene block copolymers.

Suitable embodiments of an SIS copolymer may be those commercially available under the trade designation VECTOR (TSRC Corp., of Taipei City, Taiwan). Suitable embodiments of a SEBS copolymer may be those commercially available under the trade designation KRATON G from Kraton Polymers U.S. LLC (Houston, Texas) including KRATON G 1652, KRATON G 1651, and KRATON G 1657.

The block copolymer can be present in an amount from 10 wt. % to 50 wt. %, based on the total weight of the hot melt adhesive composition. The block copolymer can be present in an amount from 10, 15, 20, 25, or 30 wt. %, to 35, 40, 45, or even 50 wt. %, based on the total weight of the hot melt adhesive composition. For example, the block copolymer may be included in an amount from 10 wt. % to 50 wt. %, 10 wt. % to 45 wt. %, 15 wt. % to 40 wt. %, 15 wt. % to 35 wt. %, or even 15 wt. % to 30 wt. %, based on the total weight of the hot melt adhesive composition.

Suitable tackifying agents can help to provide tack to the hot melt adhesive composition. Suitable tackifying agents can be selected, based on the compatibility with the polymer to help to provide tack to the hot melt adhesive composition. In some embodiments, the tackifying agent may be a styrenic copolymer tackifying resin. In embodiments having an SBC, suitable tackifying agents can help to tackify the mid-block of the SBC or to reinforce the end block of the SBC. In some embodiments, the tackifying agent can also help to lower viscosity. Suitable classes of tackifying agents include those that exhibit a softening point from 80° C. to 150° C. For example, suitable classes of tackifying agents include those that exhibit a softening point from 80° C., 90° C., 100° C., or 110° C., to 120° C., 130° C., 140° C., or even 150° C.

Example classes of tackifying agents include hydrocarbon resins such as aromatic, aliphatic, cycloaliphatic hydrocarbon resins, polydicyclopentadiene (DCPD) (e.g., modified DCPD), C5 resins, C9 resins, modified hydrocarbon resins (e.g., modified aromatic, modified aliphatic, mixed aromatic and aliphatic modified hydrocarbon resins, aromatic modified aliphatic hydrocarbon resins) and hydrogenated versions thereof. In some instances, the tackifying agent can be a non-polar tackifying agent.

Suitable tackifying agents include terpenes and rosin esters, alpha methyl styrene, polyterpene (e.g., modified polyterpene). In some instances, a tackifying agent that is primarily aromatic (e.g., greater than 75% aromatic) is preferred. For example, an aromatic tackifying agent can help to form a hot melt adhesive composition material that exhibits a suitable level of elasticity (e.g., suitably low residual deformation) and that is tack free.

In some embodiments, a hot melt adhesive composition that has a very low level of tackiness, may be desired. For example, a hot melt adhesive composition may be desired that is tacky when the hot melt adhesive composition is in a liquid phase but has no tack when the adhesive composition is in a solid phase. In some embodiments, a hot melt adhesive composition that is tack free, may be desired. For example, a preferred hot melt adhesive composition is one is tack free when the adhesive composition is in a solid phase. In some instances, a tack free hot melt adhesive composition includes a tackifying agent that associates with the end block phase such as, e.g., aromatic hydrocarbon resins, aromatic modified hydrocarbon resins, and combinations thereof.

Suitable embodiments of an aromatic hydrocarbon resin tackifier may include pure monomer aromatic tackifying resins, such as those commercially available under the KRISTALEX and PLASTOLYN series of trade designations (from Eastman Chemical Company of Kingsport, Tennessee) including, e.g., KRISTALEX 3100, PLASTOLYN 240 and PLASTOLYN 290; those available under the PICCOTEX trade designation (from Eastman Chemical Company) including PICCOTEX 120 and PICCOTEX 140; and aromatic hydrocarbon resin such as those available under the trade designation SYLVARES, including SYLVARES SA 100, SYLVARES SA 120, SYLVARES SA 140, (from Kraton Corp., of Houston, Texas). Suitable embodiments of a tackifier can include other hydrogenated resins such as those available under the trade designation NOVARES PURE 1120, 2100 and 2120 (from Rain Carbon, Inc. of Duisburg, Germany).

The tackifying agent can be present in an amount from 10 wt. % to 50 wt. %, based on the total weight of the hot melt adhesive composition. The tackifying agent can be present in an amount from 10, 15, 20, 25, or 30 wt. %, to 35, 40, 45, or even 50 wt. %, based on the total weight of the hot melt adhesive composition. For example, the tackifying agent may be included in an amount from 10 wt. % to 50 wt. %, 10 wt. % to 45 wt. %, 15 wt. % to 40 wt. %, 15 wt. % to 35 wt. %, or even 15 wt. % to 30 wt. %, based on the total weight of the hot melt adhesive composition.

Useful plasticizers include, polybutene, polyisobutylene, polyolefin copolymers (e.g., propylene-ethylene copolymers), oligomerized alpha olefins, oils (e.g., naphthenic, petroleum-based oils, paraffinic oils, mineral oils, synthetic oils, bio-based oils (e.g., derived from plants such as crops such as palm oil, sunflower oil), derivatives of oils, derivatives of fatty alcohol, liquid isoprene, and combinations thereof), and combinations thereof.

Suitable examples of plasticizers can include oils, for example petroleum-derived oils, or plant-derived oils such as crop-derived oils. Suitable examples of plasticizers can be selected from at least one of paraffinic oil and mineral oil. Suitable embodiments of a plasticizer may be mineral oils commercially available under the trade designation KAYDOL (from Sonneborn of Tarrytown, New York) including KAYDOL and those available under the KRYSTOL trade designation (from Petrochem Carless Ltd. of Surrey, England) including KRYSTOL 550. Suitable examples of plasticizers can include oils such as those available under the trade designation CATENEX, such as CATENEX T 145 (from, Shell Deutschland Oil GmbH, Hamburg, Germany), and those available under the trade designation VIVASPES, such as VIVASPES 10227 (from H&R Group US, Inc., Houston, Texas, USA).

The plasticizer can be present in an amount from 15 wt. % to 60 wt. %, based on the total weight of the hot melt adhesive composition. The plasticizer can be present in an amount from 15, 20, 25, 30, 35, 40, 45, or even 50 wt. %, to 55, 60, 65, or even 70 wt. %, based on the total weight of the hot melt adhesive composition. For example, the block copolymer may be included in an amount from 30 wt. % to 65 wt. %, 30 wt. % to 60 wt. %, 30 wt. % to 55 wt. %, 30 wt. % to 50 wt. %, 35 wt. % to 50 wt. %, or even 40 wt. % to 50 wt. %, based on the total weight of the hot melt adhesive composition.

### Optional Components

The hot melt adhesive composition can optionally include additional components such as stabilizers, antioxidants, additional polymers (such as olefin polymers (for example single site catalyzed polymers, for instance, metallocene catalyzed polymers), propylene based polymers, ethylene based polymer, and combinations thereof), waxes, adhesion promoters, coatings, anti-tack additives, colorants, fillers and combinations thereof.

For example, in some embodiments, at least one wax (such as bio-based wax, for instance a polyethylene wax, or paraffinic wax) may be present in the hot melt adhesive composition. Suitable embodiments of a wax may include polyethylene wax such as those commercially available under the trade designation GWAX 50E (by Braskem USA, of La Port, Texas, USA). The wax can be present in an amount from 10 wt. % to 35 wt. %, based on the total weight of the hot melt adhesive composition. The wax can be present in an amount from 10, 15, 20 wt. %, 25, 30, or even 35 wt. %, based on the total weight of the hot melt adhesive composition.

Useful antioxidants include, e.g., pentaerythritol tetrakis [3,(3,5-di-tert-butyl-4hydroxyphenyl) propionate], 2,2′-methylene bis(4-methyl-6-tert-butylphenol), phosphites including, e.g., tris-(p-nonylphenyl)-phosphite (TNPP) and bis(2,4-di-tert-butylphenyl) 4,4′-diphenylene-diphosphonite, di-stearyl-3,3′-thiodipropionate (DSTDP), and combinations thereof. Useful antioxidants are commercially available under a variety of trade designations including, e.g., the IRGANOX series of trade designations including, e.g., IRGANOX 1010, IRGANOX 565, and IRGANOX 1076 hindered phenolic antioxidants and IRGAFOS 168 phosphite antioxidant, all of which are available from BASF Corporation (of Florham Park, New Jersey), and ETHYL 702 4,4′-methylene bis(2,6-di-tert-butylphenol). When present, the composition can include from about 0.1 wt. % to about two wt. % antioxidant.

Hot melt adhesive compositions in a wide viscosity range can be useful. A person skilled in the art will be able adjust the application temperature as needed depending on the viscosity of a selected hot melt adhesive composition.

In some embodiments, the hot melt adhesive composition exhibits a Brookfield viscosity from 200 to 13,000 mPa·s, at a temperature from 174° C. to 176° C. when in an unfoamed form. In some embodiments, exhibits a Brookfield viscosity from 200; 500; 1,000; 1,500; 2,000; 2,500; 3,000; 3,500; 4,000; 4500; or 5000; to 6000; 7000; 8000; 9000; 10,000; 11,000, 12,000 or even 13,000 mPa·s, at a temperature from 174° C. to 176° C. as measured with ASTM D 3236 using a spindle #27,at a spindle speed of 20 rpm. For example, the hot melt adhesive composition can have a viscosity from 1000 to 13,000; 2,000 to 10,000; 3,000 to 7,000; or from 4,000 to 5,000 at a temperature from 174° C. to 176° C. as measured with ASTM D 3236 using a spindle #27,at a spindle speed of 20 rpm.

### Foam Form

The hot melt adhesive composition can be in foamed form, which also may be referred to herein as a foamed hot melt adhesive composition. The hot melt adhesive composition may comprise the bulk composition that defines voids throughout the foam. The voids can be filed with a gas, such as any suitable inert gas. In some embodiments, the voids can be filled with a gas such as any from the group of air, nitrogen, carbon dioxide, argon, helium, and combinations thereof.

The foam may be an open cell foam or a closed cell foam. In a closed cell foam, each cell is defined by its individual wall such that the voids of individual cells do not interconnect with the voids of other cells. In an open cell foam, the walls of the cells connect with the walls of adjoining cells such that the voids of adjoining cells are connected.

A hot melt adhesive composition can be generated into a foamed form mechanically, such as using mechanical equipment to create voids throughout the foam. For example, a liquid hot melt adhesive composition can be agitated to introduce a gas to form voids in the hot melt adhesive composition by using two gear pumps running with different speeds relative to each other. In another example, the hot melt adhesive composition can be pumped as a liquid stream that is joined with a gas stream under pressure. The gas stream can introduce the gas throughout the volume of the hot melt adhesive composition to form the voids. The liquid foamed hot melt adhesive composition can be allowed to cool and harden while in a foamed form to product a solid hot melt adhesive in foamed form.

Alternately, foamed hot melt adhesives can be generated chemically, such as by use of a chemical blowing agent, such as water. For example, the blowing agent can be introduced into a liquid hot melt adhesive composition. The blowing agent can react, such as with one or more components of the hot melt adhesive composition, to release a gas throughout the volume of the hot melt adhesive composition to form voids. The liquid foamed hot melt adhesive can be allowed to cool and harden while in a foamed form to product a solid foamed form.

The hot melt adhesive composition in a foamed form can have a density that is lower than that of the hot melt adhesive composition that is not a foamed form. For example, the foamed hot melt adhesive composition can have a density that is from 25, 30, 35, or 40 percent, to 45, 50, 55, 50, 65, 70, 75, 80, or 90 percent of the density of the hot melt adhesive composition that is not in a foamed form.

For example, the hot melt adhesive composition can have a density of from greater than 0.85 to 1.05 g/cc density when in a unfoamed form. In some embodiments, the density of the hot melt adhesive composition can be formed at any suitable density. For example, the hot melt adhesive composition can have a density of from 0.20, 0.25, 0.30, 0.35, 0.40, 0.45 or 0.50 g/cc to 0.55, 0.60, 0.65, 0.70, 0.75, 0.80 or 0.85 g/cc when in foamed form, as measured with the pycnometer test method at an ambient temperature of from 22° C. to 25° C.

In some embodiments, the hot melt adhesive composition is tack free (having a peak separation force of no greater than 0.1 N when in an unfoamed form (as measured in accordance with ASTM D2979-95, “Pressure sensitive tack of adhesives using an inverted probe machine.”) In some embodiments, the hot melt adhesive composition is tack free (peak separation force of no greater than 0.1 N when in a foamed form. In some embodiments, the hot melt adhesive is tack free) when in a foamed form and in the solid phase.

In some embodiments, the hot melt adhesive in a solid phase and a foamed form has a Residual Deformation value of no greater than 10%, preferably less than six %, or even less than four %, when tested according to the Residual Deformation Test at an ambient temperature from 22° C. to 25° C.

### Substrate

Typically, the substrate is a layer of a repulpable material. In some embodiments, the substrate can include at least one of paper, papyrus, cardboard, cotton fibers, high density polyethylene layer sold under the trade designation TYVEK (from Dupont, of Wilmington, Delaware), and paperboard. In some embodiments, various materials known in the art such as kraft paper, paperboard or corrugated board, paper-based substrate (single layer, multilayer, corrugated) can be used as a substrate. For example, a useful substrate can include kraft paper having a basis weight from 70 to 120 gsm.

Reference is made to the enclosed drawings by way of example, which are not meant to be limiting to the disclosures herein.

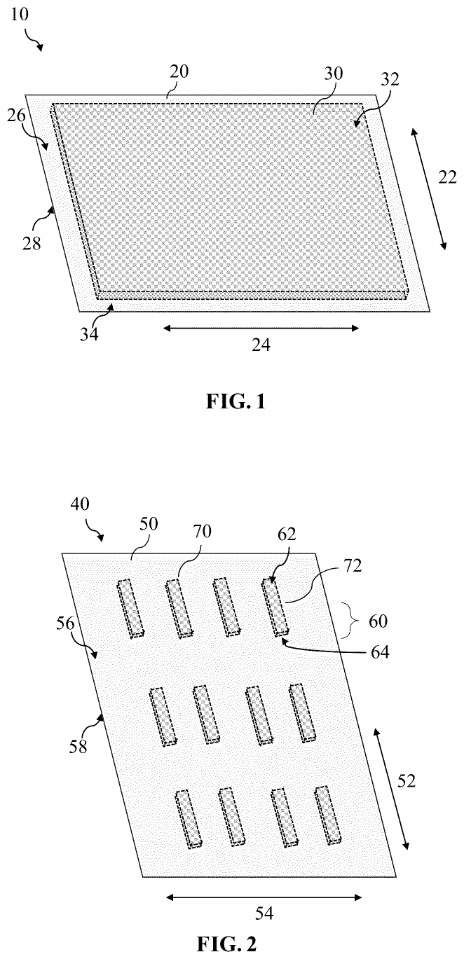

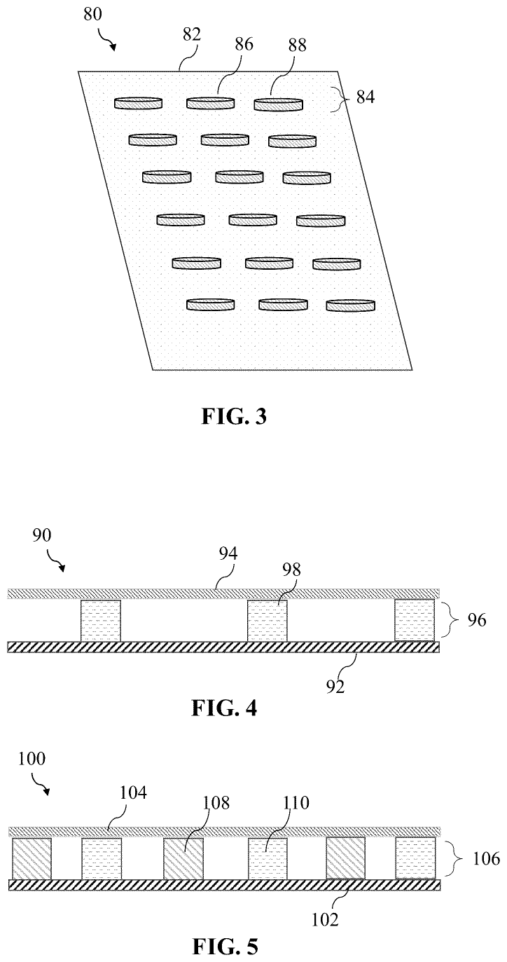

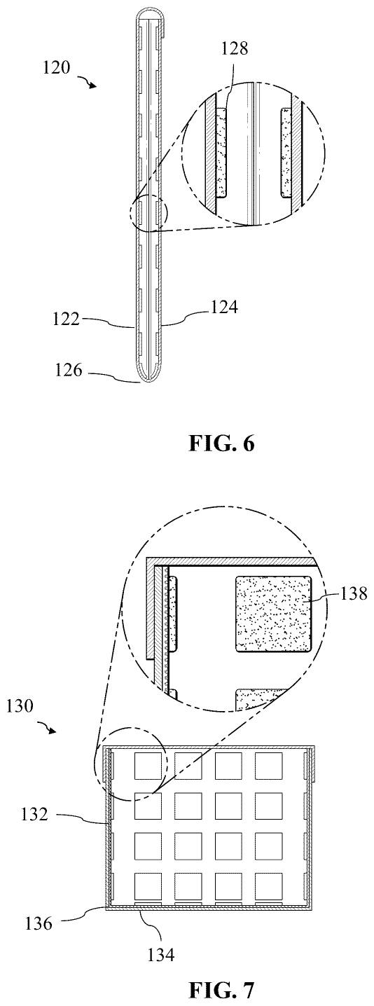

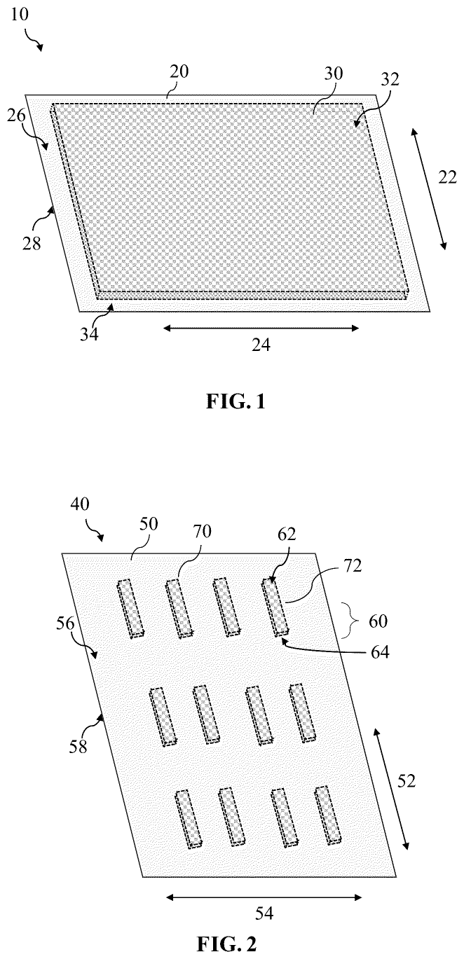

As shown in FIG. 1, in some embodiments, a multilayered structure 10 can include a first layer 20, and a second layer 30. The first layer 20 can be a substrate, and the second layer 30 can be a padding layer. For example, the first layer 20 can be sheet of repulpable material. The second layer 30 can be a layer of foamed material.

The first layer 20 has a first side 26, and a second side 28. The first layer 20 defines a length 22 and a width 24, of the first layer 20. The first side 26 of the first layer 20 defines a first face defining a first surface. The second side 28 of the first layer 20 defines a second face having a second surface.

The second layer 30 has a first side 32, and a second side 34. The first side 32 of the second layer 30 defines a first face defining a first surface. The second side 34 of the second layer 30 defines a second face defining a second surface. The distance between the first surface and second surface of the second layer 30 defines a thickness of the second layer 30. As shown in FIG. 1, the second layer 30 defines a length and a width of the second layer 30.

FIG. 2 shows a multilayered structure 40 in accordance with some embodiments. As shown, the multilayered structure 40 includes a first layer 50, and a second layer 60. The first layer 40 can be a substrate, and the second layer 50 can be a padding layer. The first layer 50 can be sheet of repulpable material. The second layer 60 can be a layer of foamed material.

The first layer 50 has a first side 56, and a second side 58. The first layer 50 defines a length 52 and a width 54, of the first layer 50. The first side 56 of the first layer 50 defines a first face defining a first surface. The second side 58 of the first layer 50 defines a second face defining a second surface.

The second layer 60 has a first side 62, and a second side 64. The first side 62 of the second layer 60 can define a first face defining a first surface. The second side 64 of the second layer 60 can define a second face having a second surface. The distance between first surface and second surface of the second layer 60 defines a thickness of the second layer 60. The thickness of the second layer can be from about 0.5 mm, 1.0 mm, 1.5 mm, to about 2.0, 2.5, 3.0, 3.5, or even 4.0 mm. The thickness of the second layer is not limited by the illustrations herein and can be any suitable thickness. The width of the layer can be from about 0.5 mm, one, two, three, four, or five mm, to about six, seven, eight, nine, ten, 11, 12, 13, 14, or 15 mm. The width of the second layer is not limited by the illustrations herein and can be any suitable thickness.

As shown in FIG. 2, the second layer 60 can include one or more pads, for example a first pad 70 and second pad 72, which collectively comprise a plurality of pads. The plurality of pads can define the second layer 60. In some embodiments, the plurality of pads defines a padding layer. The plurality of pads can define the thickness of the padding layer. For example, each pad of the plurality of pads can define a first side and a second side, with the first side and second side of each pad of the plurality of pads generally corresponding to the first side 62 second side 64. As shown in FIG. 2, the first pad 70 and second pads 72 are generally shaped as rectangle, having a length and a width. However, pads having any suitable size or shape can be used. For example, the thickness of the pads can be from about 0.5 mm, 1.0 mm, 1.5 mm, to about 2.0, 2.5, 3.0, 3.5, or even 4.0 mm. The thicknesses of the pads are not limited by the illustrations herein and can be any suitable thickness. The width of the pads can be from about 0.5 mm, one, two, three, four, or five mm, to about six, seven, eight, nine, ten, 11, 12, 13, 14, or 15 mm. The widths of the pads are not limited by the illustrations herein and can be any suitable width.

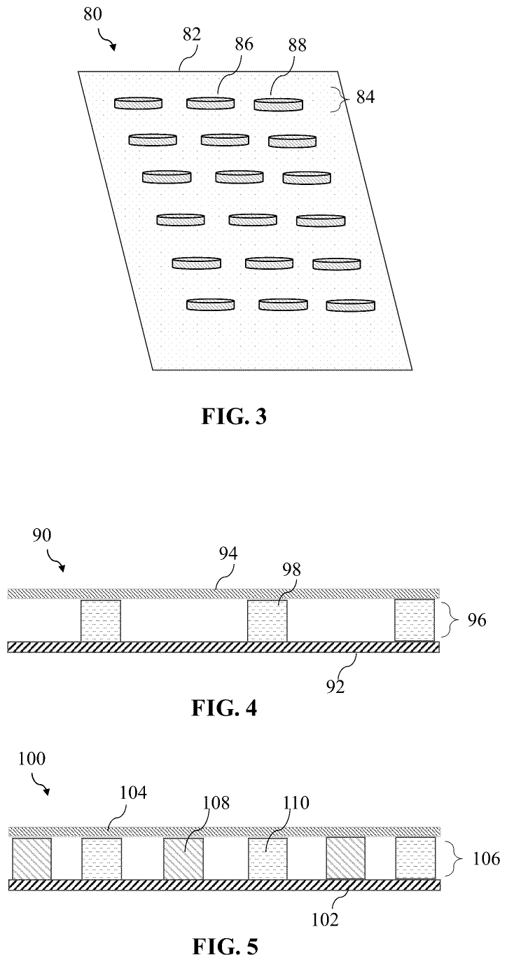

FIG. 3 shows a multilayered structure 80 in accordance with some embodiments. As shown in FIG. 3, the multilayered structure 80 includes a first layer 82, and a second layer 84. The first layer 82 can be a substrate, and the second layer 84 can be a padding layer. The first layer 80 can be sheet of repulpable material. The first layer 80 can include features corresponding to those described with reference to FIG. 2, such a first side, a second side, a first surface, a first face, a second surface, a second face, a first length, and a first width, the Second layer 60 can be a layer of foamed material.

As shown in FIG. 3, the second layer 84 can include one or more pads, for example a first pad 86 and second pad 88, which collectively comprise a plurality of pads. The plurality of pads can define the second layer 84. In some embodiments, the plurality of pads defines a padding layer. As shown in FIG. 2, the first pad 86 and second pads 88 are generally shaped as rounded shape. However, pads having any suitable size or shape can be used.

FIG. 4 shows a multilayered structure 90 in accordance with some embodiments. As shown in FIG. 4, the multilayered structure 90 includes a first wall 92, a second wall 94, and a second layer 96. As shown in FIG. 4, the second layer 96 includes at least a first pad 98. In some embodiments, the second layer 96 can include more pads than the first pad 98. In some embodiments, the second layer 96 can include a plurality of the first pad 98. The first pad 98 is an impact absorbing pad, such that the second layer 96 comprises a padded layer.

In some embodiments, the multilayered structure 90 can be formed by positioning the first pad 98 to one of the first wall 92 or the second wall 94. The first wall 92 and the second wall 94 can be joined in facing relationship with each other by attaching the first wall 92 and second wall 94 along an outer border of the first wall 92 and second wall 94 with the first pad 98 in between the first wall 92 and second wall 94. In some embodiments, the first wall 92 and the second wall 94 can be joined in facing relationship with each other by attaching one of the first wall 92 and second wall 94 to the first pad 98 that is positioned on the other of the first wall 92 and second wall 94.

FIG. 5 shows a multilayered structure 100 in accordance with some embodiments. As shown in FIG. 5, the multilayered structure 100 includes a first wall 102, a second wall 104, and a second layer 106. As shown in FIG. 5, the second layer 106 includes at least a first pad 108 and a second pad 110. In some embodiments, the second layer 106 can include a plurality of the first pad 108 and second pad 110. The first pad 108 and second pad 110 are impact absorbing pads, such that the second layer 106 comprises a padded layer.

In some embodiments, the multilayered structure 100 can be formed by positioning at least one of the first pad 108 and second pad 110 to one of the first wall 102 or the second wall 104, and the other of the first pad 108 and second pad 110 to the other of the first wall 102 or the second wall 104. The first wall 102 and the second wall 104 can be joined in facing relationship with each other by attaching the first wall 102 and second wall 104 along an outer border of the first wall 102 and second wall 104 with the first pad 108 and second pad 110 in between the first wall 102 and second wall 104. In some embodiments, the first wall 102 and the second wall 104 can be joined in facing relationship with each other by attaching one of the first wall 102 and second wall 104 to the first pad 108 and second pad 110 positioned on the other of the first wall 102 and second wall 104.

In some embodiments, a mailer can comprise the multilayered structure of any embodiment disclosed herein. In general, a mailer is any device that can be positioned in surrounding engagement with an object to be contained. The mailer can be used to enclose the object while the object is being moved, for instance, while the object is shipped. The mailer can be used to enclose the object while the object is being shipped through the mail. The multilayered structure can form at least a portion of the mailer, such that the mailer includes a padded layer. The mailer can be any suitable shape or design for being positioned in surrounding engagement with an object to be contained. For example, the mailer can be an envelope, a box, a cylinder, a pyramid, a container of trapezoidal shape, a bag. The mailer can be formed by shaping a multilayered structure, such as any embodiment disclosed here, into an envelope or a box.

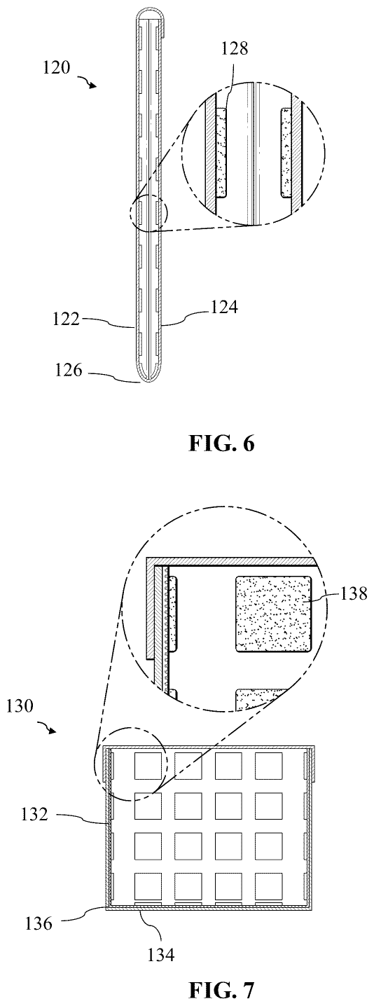

FIG. 6 is a side cut away view of an enclosure 120 that includes a multilayer structure. As shown in FIG. 6, in some embodiments, an enclosure 120 can include at least a first panel 122 and a second panel 124. In some embodiments, on or both the first panel 122 and second panel 124 can be formed using any embodiment of a multilayered structure described herein. For example, a multilayered structure can be used to form the enclosure 120, which can be an enclosure for containing an object as it travels via a shipping method (e.g., an envelope), the enclosure 120 having a first panel 122 and a second panel 124 joined along at least one border 126. As shown by the inset in FIG. 6, the first and second panels 122, 124 can include a padded layer 128, such as those described with reference to any of FIGS. 1 to 5 herein.

FIG. 7 is a side cut away view of an enclosure 130 that includes a multilayer structure. As shown in FIG. 7, in some embodiments, an enclosure 130 can include at least a first panel 132 and a second panel 134. In some embodiments, one or both the first panel 132 and second panel 134 can be formed using any embodiment of a multilayered structure described herein. For example, a multilayered structure can be positioned to define the enclosure 130, such as a box, having the first panel 132 and the second panel 134 joined along at least one border 136. As shown by the inset in FIG. 7, the first and second panels 132, 134 can include a padded layer 138, such as those described with reference to any of FIGS. 1 to 5 herein. In some embodiments, one or more examples of a multilayered structure can be joined with one or more second, third, fourth, fifth, or even sixth examples of a multilayered structure to form any suitable enclosure that can define an inner volume.

In some embodiments, a multilayered structure that defines a panel can be positioned in curved orientation with itself to form a wall that defines a cylinder (not shown) defining a length and diameter. In some embodiment, the outer diameter of the cylinder can be defined by a sheet of repulpable material. In some embodiments, an inner diameter of the cylinder can be defined by a surface of one or more layers of foamed hot melt adhesive composition

In some embodiments, a padded layer can be positioned on a surface of a substrate such that substrate can be used to form a wall of an enclosure and the padded layer can provide an impact absorbing layer to protect objects positioned inside the enclosure.

In some instances, certain kinds of foam forms can exhibit impact absorbing characteristics. For example, an open cell foam can absorb impacts and function as a spring, returning to its original shape after compression. Such behavior may be a function of air movement between connected cells in the foam.

In some instance, the density and chemical makeup of the material that forms the foam can be controlled to provide a suitable level of impact absorption. For example, open cell foam is often soft and breathable, and is generally more flexible and can more easily conform to sealing applications than closed cell foam. Open cell foam can also be more easily manufactured along a range of densities. For certain padding arrangements an open cell foam may be less suitable than closed cell. For example, if a certain level of elasticity or resilience is desired, a closed cell foam may be more suitable.

The substrate and the padded layer can be chosen such that the entire multilayered structure is repulpable. For example, the multilayered structure may be configured such that if the entire multilayered structure is shredded and added to water to produce a slurry, the resulting slurry can be used to form a substrate. For instance, the padded layer may be configured to represent a weight percentage of the multilayered structure that allows the entire multilayered structure to be repulpable as a whole. In some embodiments, the padded layer may be configured to be present in no greater than 15 wt. %, no greater than 10 wt. %, or no greater than five wt. %, based on the total weight of the multilayered structure.

In some embodiments, the padded layer may be removeable from the substrate, such that the substrate can be repulped separately from the padded layer. For instance, the padded layer may exhibit a tackiness that helps it to be easily removed from the substrate. The padded layer can be configured such that it exhibits a density less than that of water, such that when placed water, the padded layer can be skimmed from the surface of the water.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the above described features.

### EXAMPLES

The following non-limiting examples are included to further illustrate various embodiments of the instant disclosure and do not limit the scope of the instant disclosure.

### Test Methods

### Viscosity Test Method

The Brookfield viscosity is measured in accordance with ASTM D 3236, at a test sample temperature from 174° C. to 176° C., using a spindle #27, at a spindle speed of 20 rpm.

### Residual Deformation Test Method

The Residual Deformation Test Method is carried out by forming a test sample of the composition to be tested. The test is carried out on a compression testing machine (MTS model 2/M, from MTS Systems Corporation, Eden Prairie, Minnesota) using compression analysis software (TestWorks 4, from MTS). The force cell is set at 10 kN.

The test sample is formed as a cylinder having a diameter of 4.5±0.1 cm and a height of 2.5±0.1 cm, and then placed at an ambient temperature from 24° C. to 25° C. for 24 hours.

The test sample is compressed a distance of 10 mm along the direction of the thickness (i.e., the test sample is compressed to 40% of its original height). The compression is carried out five times. Each compression includes a compression speed of 300 mm/min at an ambient temperature from 22° C. to 23° C. The maximum compressive force applied to the test sample and the compression height of each compression is measured by the compression testing machine.

The final height of the test sample is measured within five seconds after the test sample has been compressed five times.

### Tack Test Method

The Tack Test Method is carried out using a rheometer (model Netzsch Kinexus pro +, from NETZSCH-Gerätebau GmbH, of Germany), using testing reference ASTM D 2979-95. The test is conducted with the sample to be tested at a temperature between 23° C. and 25° C. A test probe with a flat tip having a 20 mm diameter is used (about 3.14 square cm). The surface area of the sample to be tested is limited to 1.54 square cm (about half the area of the probe) to ensure that the entire surface of the sample to be tested is brought in contact with the probe tip.

The probe is brought into contact with the sample to be tested and then removed. The baseline trigger force for detecting the surface of the sample to begin detection is one (1) N force. The tack value is given as the value of the peak amount of force needed to separate the probe from the sample to be tested. A sample to be tested is considered tack free if the peak separation force is less than 0.1 N.

### Stain Test Method

The Stain Test is carried out to determine whether any components of the hot melt adhesive composition (e.g., oil) migrates from the composition to a substrate that the composition has been in contact with.

The Stain Test is conducted by positioning the sample to be tested in contact with a substrate (A4 laser jet print paper, basis wt. of 70 gsm (from Clairfontaine, of France) and left for at least 100 hours at an ambient temperature of about 50° C. After the test duration, the composition is removed from the substrate and the substrate is visually inspected for any visual evidence of a difference in the color or shade of the portion of the substrate that was in contact with the composition and the portion of the substrate that was not.

### Density Test Method

The density of the sample to be measured is calculated by pycnometer. A pycnometer (a glass flask with a close-fitting ground glass stopper with a capillary hole through it) is used.

The mass of an empty, dry pycnometer (m0) is determined. The pycnometer is filled with water and the glass stopper is pressed onto the pycnometer opening such that water leaks through the capillary hole. The water that leaks through the capillary hole is dried with filter paper. The combined mass of the pycnometer with the water is measured to give m1. The difference between the mass of m0 and m1 gives the mass of the water (m_{H2O}) that fills the internal volume of the pycnometer.

The internal volume of the pycnometer (V0) can be found by dividing the mass of the water (m_{H2O}) by the known density of water at room temperature (ρ_{H2O}, which is 1 gram per milliliter (g/mL)).

The item to be measured is weighed to give mᵢₜₑₘ. The combined mass of the item to be measured and the pycnometer is m₂ (i.e., m0+mᵢₜₑₘ=m₂). Alternatively, m₂ can be found by placing the item to be measured inside the pycnometer and the combined mass of the pycnometer and the item to be measured can be measured.

The item is placed inside the pycnometer. Water is added to the pycnometer with the item to be measured inside such that the pycnometer is filled with water. The glass stopper is pressed onto the pycnometer opening such that water leaks through the capillary hole. The water that leaks through the capillary hole is dried with a filter paper and the total mass (mₜₒₜ) of the item to be measured, the added water, and the pycnometer is measured. The mass of the water that was added (m′_{H2O}) is measured by subtracting m₂ from mₜₒₜ. The volume of water added to the pycnometer (V′_{H2O}) containing the item to be measured is calculated by dividing m′_{H2O} by the known density of water at room temperature (ρ_{H2O}). (For example, V′_{H2O}=m′_{H2O}/ρ_{H2O}).

The volume of the item to be measured can be found by subtracting V′_{H2O} from V0 to give Vᵢₜₑₘ and the density of the item to be measured is found by dividing mᵢₜₑₘ by Vᵢₜₑₘ to give the density.

Samples of hot melt adhesive compositions were prepared by combining the compositions shown in Tables 1 and 3. The components included in the samples of hot melt adhesive compositions included the following, provided here along with the trade designation.

Aromatic hydrocarbon tackifying resin (PICCOTEX 120, from Eastman Chemical Company); paraffinic process oil (CATENEX T 145, from Shell USA, Inc., of Houston, Texas) styrene ethylene/butylene (SEBS) block copolymer (TAIPOL 6152, from TSRC Corp. of Kaoshung City, Taiwan), phenolic antioxidant stabilizer (IRGANOX 1010, from BASF); antioxidant (Dilauryl thiodipropionate (DLTDP), ARENOX DL, from Reagens U.S.A. Inc., of Bayport, Texas), napthalenic process oil (NYFLEX 223, from Nynas of Stockholm, Sweden), cycloaliphatic hydrocarbon resin (ESCOREZ 5320, from ExxonMobil, Irving, Texas), hydrogenated hydrocarbon tackifying resin (ARKON P 125, from Arakawa, Chemical of Chicago, Illinois), aromatic hydrocarbon tackifying resin (PICCOTEX 120, from Eastman Chemical Company), aromatic hydrocarbon tackifying resin (SYLVARES SA 100, SYLVARES SA 120, SYLVARES SA 85, from Kraton Corp., of Houston, Texas), polyterpene resin tackifying resin (SYLVARES TRB 115 (Kraton Corp.), butadiene/styrene thermoplastic copolymer (SBS) (CALPRENE 500, from Dynasol, of Greensboro, Georgia), butadiene/styrene thermoplastic copolymer (SBS) (CALPRENE 540, from Dynasol), ethylene-butylene/styrene thermoplastic copolymer (SEBS) (CALPRENE 6120, from Dynasol), styrenic block copolymer (VECTOR 4411, from TSRC Corp., of Taipei City, Taiwan); styrenic block copolymer (VECTOR 4111, from TSRC Corp.); SEBS copolymer (KRATON G 1657, from Kraton Polymers); and pentaerythritol rosin ester (SYLVALITE RE 100S, from Kraton Polymers), bio-based aliphatic plasticizer (VIVASPES 10227, from H&R Group), hydrogenated resin (NOVARES PURE 2120 from Rain Carbon, Inc.), and bio-based isomeric polyethylene wax (GWAX 50E from Braskem USA).

The samples given in Tables 1, 3, and 4 were tested in accordance with the test methods disclosed here. Table 4 shows the same compositions (given in weight percentage) as the samples shown in Table 3 (in parts). The results are given in Tables 2 and 5, respectively. Table 6 shows additional sample compositions and test results of those compositions, tested in accordance with the test methods disclosed here.

TABLE 1
Composition of Samples to be Tested

| | Wt. % in Sample | | | | | | | | | | | | | |
|---|---|---|---|---|---|---|---|---|---|---|---|---|---|---|
| Component | Com | A | B | C | D | E | F | G | H | I | J | K | L | M |
| PICCOTEX 120 | 22.7 | 22.7 | | | | | | 22.7 | 22.7 | 22.7 | 22.7 | 22.7 | 22.7 | |
| CATENEX T 145 | 50 | | 50 | 50 | 50 | 50 | 50 | 50 | 50 | 50 | 50 | 50 | 50 | 50 |
| TAIPOL 6152 | 26.5 | 26.5 | 26.5 | 26.5 | 26.5 | 26.5 | 26.5 | | | | | | | 26.5 |
| IRGANOX 1010 | 0.60 | 0.60 | 0.60 | 0.60 | 0.60 | 0.60 | 0.60 | 0.60 | 0.60 | 0.60 | 0.60 | 0.60 | 0.60 | 0.60 |
| ARENOX DL | 0.2 | 0.2 | 0.2 | 0.2 | 0.2 | 0.2 | 0.2 | 0.2 | 0.2 | 0.2 | 0.2 | 0.2 | 0.2 | 0.2 |
| NYFLEX 223 | | 50 | | | | | | | | | | | | |
| ESCOREZ 5320 | | | 22.7 | | | | | | | | | | | |
| ARKON P 125 | | | | 22.7 | | | | | | | | | | |
| PICCOTEX 140 | | | | | 22.7 | | | | | | | | | |
| SYLVARES SA 100 | | | | | | 22.7 | | | | | | | | |
| SYLVARES SA 85 | | | | | | | 22.7 | | | | | | | |
| CALPRENE 500 | | | | | | | | 26.5 | | | | | | |
| CALPRENE 540 | | | | | | | | | 26.5 | | | | | |
| CALPRENE 6120 | | | | | | | | | | 26.5 | | | | |
| VECTOR 4411 | | | | | | | | | | | 26.5 | | | |
| VECTOR 4111 | | | | | | | | | | | | 26.5 | | |
| KRATON G 1657 | | | | | | | | | | | | | 26.5 | |
| SYLVALITE RE | | | | | | | | | | | | | | 22.7 |
| 100S | | | | | | | | | | | | | | |

TABLE 2
Test Results of Samples in Table 1

| | Sample | | | | | | | | | | | | | |
|---|---|---|---|---|---|---|---|---|---|---|---|---|---|---|
| Test Result | Com | A | B | C | D | E | F | G | H | I | J | K | L | M |
| Plastic | 3.0 | 7.76 | 15.5 | 2.5 | 2.6 | 2.6 | 4.12 | 8.1 | 4.5 | 3.8 | 2.3 | 7.0 | 4.7 | 4.7 |
| Deformation | | | | | | | | | | | | | | |
| (%) | | | | | | | | | | | | | | |
| Max Applied | 1105 | 1500 | 167 | 307 | 57 | 1007 | 1284 | 454 | 739 | 960 | 794 | 133 | 538 | 246 |
| Force (N) | | | | | | | | | | | | | | |
| Brookfield | 5600 | 2692 | 1378 | 1730 | 12000 | 2532 | 2413 | 1683 | 2198 | 16420 | 83600 | 1750 | 7950 | 11930 |
| Viscosity at | | | | | | | | | | | | | | |
| 174° C. to | | | | | | | | | | | | | | |
| 176° C. | | | | | | | | | | | | | | |
| (mPa · s) | | | | | | | | | | | | | | |
| Stain Test | NO | NO | YES | YES | NO | NO | NO | YES | YES | NO | NO | YES | NO | YES |
| (visual | | | | | | | | | | | | | | |
| detection) | | | | | | | | | | | | | | |
| Tack (peak | 0 | 0 | 3.73 | YES | 0 | 0 | 0.21 | 0 | 0 | 0 | 0.5 | 1.03 | 0.31 | 0.2 |
| separation | | | | | | | | | | | | | | |
| force (N)) | | | | | | | | | | | | | | |

TABLE 3
Composition of Samples to be Tested (continued)

| | Amount in Each Sample (Given In Parts) | | | | | | | |
|---|---|---|---|---|---|---|---|---|
| Component | N | O | P | Q | R | S | T | U |
| PICCOTEX | 22.7 | 22.7 | 22.7 | 27.2 | 25 | 18.1 | 22.7 | 22.7 |
| 120 | | | | | | | | |
| CATENEX T | 60 | 40 | 45 | 50 | 50 | 50 | 50 | 50 |
| 145 | | | | | | | | |
| TAIPOL 6152 | 26.5 | 26.5 | 26.5 | 26.5 | 26.5 | 26.5 | 31.8 | 21.2 |
| IRGANOX | 0.60 | 0.60 | 0.60 | 0.60 | 0.60 | 0.60 | 0.60 | 0.60 |
| 1010 | | | | | | | | |
| ARENOX DL | 0.2 | 0.2 | 0.2 | 0.2 | 0.2 | 0.2 | 0.2 | 0.2 |

TABLE 4
Composition of Samples to be Tested (continued)

| | Wt. % in Sample | | | | | | | |
|---|---|---|---|---|---|---|---|---|
| Component | N | O | P | Q | R | S | T | U |
| PICCOTEX | 20.6 | 25.2 | 23.9 | 26.0 | 24.4 | 19.0 | 21.6 | 24.0 |
| 120 | | | | | | | | |
| CATENEX T | 54.5 | 44.4 | 47.4 | 47.8 | 48.9 | 52.4 | 47.5 | 52.8 |
| 145 | | | | | | | | |
| TAIPOL 6152 | 24.1 | 29.4 | 27.9 | 25.4 | 25.9 | 27.8 | 30.2 | 22.4 |
| IRGANOX | 0.5 | 0.7 | 0.6 | 0.6 | 0.6 | 0.6 | 0.6 | 0.6 |
| 1010 | | | | | | | | |
| ARENOX DL | 0.2 | 0.2 | 0.2 | 0.2 | 0.2 | 0.2 | 0.2 | 0.2 |

TABLE 5
Test Results of Samples in Table 3 (and Table 4)

| | Wt. % in Sample | | | | | | | |
|---|---|---|---|---|---|---|---|---|
| Component | N | O | P | Q | R | S | T | U |
| Plastic Deformation | 2.2 | 3.6 | 4.5 | 4.7 | 3.1 | 3.1 | 3.0 | 2.2 |
| (%) | | | | | | | | |
| Max Applied Force | 643 | 1590 | 1292 | 1362 | 1341 | 871 | 1060 | 930 |
| (N) | | | | | | | | |
| Brookfield Viscosity | 2520 | 18780 | 9413 | 6092 | 5392 | 5228 | 13650 | 2090 |
| at 174° C. to 176° C. | | | | | | | | |
| (mPa · s) | | | | | | | | |
| Stain Test (visual | NO | NO | NO | NO | NO | NO | NO | YES |
| detection) | | | | | | | | |
| Tack (peak separation | 0 | 0 | 0 | 0 | 0 | 0 | 0 | 0 |
| force (N)) | | | | | | | | |

TABLE 6
Composition of Samples to be Tested (continued) and Test Results

| | Wt. % in Sample | |
|---|---|---|
| Component | V | W |
| VIVASPES 10227 | 30.6 | 30.6 |
| IRGANOX 1010 | 0.6 | 0.6 |
| ARENOX DL | 0.2 | 0.2 |
| Sylvares SA 120 | — | 6.4 |
| Novares Pure 2120 | 6.4 | — |
| Sylvares TRB 115 | 15.9 | 15.9 |
| G wax 50E | 20.9 | 20.9 |
| Plastic Deformation (%) | 3.1 | 10 |
| Max Applied Force (N) | — | — |
| Brookfield Viscosity at 174° C. to 176° C. (mPa · s) | 7750 | 15000 |
| Stain Test (visual detection) | NO | NO |
| Tack (peak separation force (N)) | 0 | 0 |

Disclosed herein is a foamed hot melt adhesive positioned with a repulpable substrate and which exhibits the ability to absorb shock when in a foam form. The hot melt adhesive exhibits several characteristics. The substrate can be a formed from a material such as any of paper, papyrus, cardboard, and paperboard. The hot melt adhesive can be positioned with the substrate to form a multilayered structure, with the weight percentage of the hot melt adhesive being no greater than 15% of the total weight of the multilayered structure. For example, the substrate can be formed from any of paper, papyrus, cardboard, and paperboard and the substrate can comprise at least 85 wt. % of the total weight of the multilayered structure.

Disclosed herein are hot melt adhesive compositions that can be used to form a hot melt adhesive in a foam form such that the foam is elastic and exhibits a damping characteristic as measured by the Residual Deformation Test. Useful foamed hot melt adhesives have residual compression values of no greater than 10%, no greater than six %, or even no greater than four %, when measured with the Residual Deformation Test.

The hot melt adhesive can be tack free after solidifying to avoid adhering to an undesired particle during the production of a multilayered structure, and any further processing of the multilayered structure. The hot melt adhesive can have a tack value of less than one N when measured with the Tack Test.

The hot melt adhesive can be stain free when positioned on a substrate that is repulpable, such as being formed of cellulosic fibers. That is, the plasticizer in the hot melt adhesive does not migrate from the hot melt adhesive when measured with the Stain Test.

It has been observed that certain suitable hot melt adhesive compositions disclosed herein, such as the sample compositions labeled comparative (Com), D, E, and I, in Tables 1 and 2 exhibit all three characteristics. For example, hot melt adhesive compositions, such as those that include from 20 wt. % to 30 wt. % SEBS block copolymer, from 40 wt. % to 60 wt. % mineral oil, and from 20 wt. % to 25 wt. % a modified styrene copolymer tackifying resin (PICCOTEX 120, PICCOTEX 140), surprisingly exhibit all three characteristics. Another tackifying resin that has been observed to produce a hot melt adhesive that also exhibits all three characteristics was SYLVAREZ SA 100.

Compositions containing certain plasticizers, such as DCPD 120° C., were observed to result in staining behavior when subjected to the Stain Test. Certain compositions containing alternative tackifying resins, such as C9 resins or pentaerythritol rosin esters, exhibited certain levels of residual tack, and in some cases, unsuitable levels of residual deformation performance.

What is claimed is:

1. A multilayered structure comprising:
a first layer comprising a first sheet of repulpable material, the first layer having a first side defining a first face,
a second layer in direct contact with the first face of the first layer and including a hot melt adhesive composition in foam form such that a density of the second layer is no greater than 0.85 g/cc.

2. The multilayered structure of claim 1, wherein the hot melt adhesive composition comprises from 10 wt. % to 50 wt. % a SEBS block copolymer, from 15 wt. % to 60 wt. % oil, and from 5 wt. % to 50 wt. % a tackifying resin.

3. The multilayered structure of claim 1, wherein the hot melt adhesive composition comprises from 10 wt. % to 50 wt. % a SEBS block copolymer, from 15 wt. % to 60 wt. % mineral oil, and from 5 wt. % to 50 wt. % a styrenic polymer tackifying resin.

4. The multilayered structure of claim 1, wherein the hot melt adhesive composition comprises from 15 wt. % to 45 wt. % a SEBS block copolymer, from 20 wt. % to 55 wt. % mineral oil, and from 20 wt. % to 40 wt. % a styrenic polymer tackifying resin.

5. The multilayered structure of claim 1, wherein the hot melt adhesive composition comprises from 20 wt. % to 40 wt. % a SEBS block copolymer, from 35 wt. % to 50 wt. % mineral oil, and from 20 wt. % to 25 wt. % a styrenic polymer tackifying resin.

6. The multilayered structure of claim 3, wherein the tackifying resin is a modified styrenic tackifier.

7. The multilayered structure of claim 1, wherein the hot melt adhesive composition exhibits a peak separation force of no greater than 0.1 N, when measured in accordance with the Tack Test Method.

8. The multilayered structure of claim 1, wherein the second layer exhibits a residual deformation value of no greater than 10% when tested according to the Residual Deformation Test.

9. The multilayered structure of claim 1, wherein the second layer exhibits a residual deformation value of no greater than six % when tested according to the Residual Deformation Test.

10. The multilayered structure of claim 1, wherein the repulpable material comprises at least one from the group of paper, papyrus, cardboard, and paperboard.

11. The multilayered structure of claim 1, wherein the density of the second layer is no greater than 0.50 g/cc.

12. The multilayered structure of claim 1, wherein the density of the second layer is no greater than 0.25 g/cc.

13. The multilayered structure of claim 1 and further comprising:
a third layer in direct contact with the second layer, the third layer comprising a second sheet of repulpable material.

14. The multilayered structure of claim 1 and further comprising:
a third layer in direct contact with the second layer, the third layer comprising a second sheet of repulpable material defining a second face; and
a fourth layer in direct contact with the second face of the third layer and comprising a hot melt adhesive composition in foam form such that a density of the fourth layer is no greater than 0.85 g/cc.

15. A multilayered structure comprising:
a first layer comprising a sheet of repulpable material, the first layer having a first side, and a second side opposite the first side and defining a second face,
a plurality of energy absorbing pads positioned in direct contact with the first layer, each pad of the plurality of energy absorbing pads positioned at a discrete location and separate from each of the other pads of the plurality of energy absorbing pads,
the second layer in direct contact with the second face of the first layer and comprising a hot melt adhesive composition defining a bulk material, the adhesive composition in foam form and exhibiting a density of no greater than 0.85 g/cc.

16. The multilayered structure of claim 15, wherein the second layer comprises the hot melt adhesive composition in foamed form and exhibiting a residual deformation value of no greater than 10% when tested according to the Residual Deformation Test.

17. The multilayered structure of claim 15, wherein the second layer comprises the hot melt adhesive composition in foamed form and exhibiting a residual deformation value of no greater than six % when tested according to the Residual Deformation Test.

18. The multilayered structure of claim 15, wherein the hot melt adhesive composition is in a foamed form and exhibits a peak separation force of no greater than 0.1 N, when measured in accordance with the Tack Test Method.

19. An enclosing article comprising:
a first wall; and
a second wall;
the first wall and second wall positioned in facing arrangement to one another and bonded to each other along an outer border of each of the first and second wall,
at least one of the first wall and the second wall comprising a first layer comprising
a sheet of repulpable material, the first layer having a first side, and a second side opposite the first side and defining a second face, and
a second layer in direct contact with the second face of the first layer and comprising a hot melt adhesive composition in foam form and exhibiting a density of no greater than 0.85 g/cc.

20. The enclosing article of claim 19, wherein the second layer comprises a plurality of energy absorbing pads in foamed form and exhibiting a residual deformation value of no greater than 10% when tested according to the Residual Deformation Test.
